(19) United States
(12) Patent Application Publication
(10) Pub. No.: US 2026/0211134 A1
(43) Pub. Date: Jul. 23, 2026

(54) PREPARATION METHOD OF QUARTZ REFERENCE SAMPLES FOR CALIBRATION OF A LUMINESCENCE DATING INSTRUMENT

(71) Applicant: National Institute of Metrology, China, Beijing (CN)

(72) Inventors: Dehong LI, Beijing (CN); Xuan ZHANG, Beijing (CN); Hui ZHAO, Beijing (CN); Shuai ZHANG, Beijing (CN); Jianwei HUANG, Beijing (CN); Sunjun JIN, Beijing (CN); Jianbo CHENG, Beijing (CN); Dongyang LI, Beijing (CN); Xiaocui LU, Beijing (CN); Yue LI, Beijing (CN); Xiaole ZHANG, Beijing (CN); Chuanfeng LIU, Beijing (CN); Yilun XU, Beijing (CN); Taiwei SHI, Beijing (CN)

(73) Assignee: National Institute of Metrology, China, Beijing (CN)

(21) Appl. No.: 19/454,900

(22) Filed: Jan. 21, 2026

(30) Foreign Application Priority Data
Jan. 22, 2025 (CN) 202510100906.9

(51) Int. Cl. G01T 7/00; G01T 1/202

(52) U.S. Cl. CPC G01T 7/005; G01T 1/2023

(57) ABSTRACT

A preparation method for a quartz reference sample for calibration of a luminescence dating instrument includes the following steps: preparing a quartz glass front wall, a quartz glass rear wall and an annular gasket; placing the annular gasket between the quartz glass front wall and the quartz glass rear wall, and placing a quartz sample in a center hole of the annular gasket; wrapping the loading device with aluminum foil, placing the loading device on a dedicated stand and positioning the dedicated stand at a measuring point of a reference radiation field; measuring an air kerma rate at the measuring point; calculating a conversion coefficient from air kerma to an absorbed dose of quartz; calculating an absorbed dose of the quartz sample; assessing the homogeneity of the quartz sample; and assessing the stability of the absorbed dose of quartz.

### CROSS-REFERENCE TO RELATED APPLICATION

This patent application claims the benefit and priority of Chinese Patent Application No. 202510100906.9 filed with the China National Intellectual Property Administration on Jan. 22, 2025, the disclosure of which is incorporated by reference herein in its entirety as part of the present application.

### TECHNICAL FIELD

The present disclosure relates to the field of luminescence dating technology, and in particular to a preparation method of quartz reference samples for calibration of a luminescence dating instrument.

### BACKGROUND

After being buried, minerals accumulate luminescence signals by absorbing ionizing radiations generated from the decay of radioactive substances such as uranium, thorium, and potassium in an environment. When mineral grains are heated or irradiated by light beams in a laboratory, the natural luminescence signals accumulated in the burial period can be stimulated. As the natural luminescence signals of the minerals are positively correlated with the radiation energy (dose) absorbed, an equivalent dose can be derived from the measured natural luminescence signals by establishing a functional relationship between the luminescence signals and the radiation dose; and the burial age of the minerals can be obtained by dividing the equivalent dose by an environmental dose rate. This process is referred to as luminescence dating.

A method for establishing the functional relationship between the luminescence signal and the radiation dose is that a built-in β radiation source in a luminescence dating instrument is used to irradiate the samples with multiple determined doses, and corresponding luminescence signals are measured. The method of performing multiple irradiations is to control a specific irradiation time (generally in seconds) under the built-in β radiation source of the sample luminescence dating instrument through the instrument. As the radioactive activity and dose rate of the radiation source gradually decrease over time, it is necessary to perform dose calibration by using a quartz sample (that is, standard quartz) that has been independently irradiated with a known equivalent dose (absorbed dose), thereby obtaining the accurate dose rate of the built-in radiation source of the instrument.

For the conventional multi-grain (single-aliquot) luminescence dating, the calibration of the dose rate of the laboratory radiation source is performed based on the multi-grain standard quartz. In recent years, with the advancement of dating technology, a single-grain optically stimulated luminescence dating method for quartz and potassium feldspar has been gradually improved. This method can determine the degree of bleaching of the sample prior to deposition and the mixing of mineral grains during different sedimentary processes. In principle, a sedimentary age can be obtained for each individual mineral grain, and the testing efficiency of this method is far higher than that of single-aliquot optically stimulated luminescence dating. Therefore, this method has been more and more widely used, and is particularly applicable to determining the chronological ages of samples from complex sedimentary environments (such as archaeological site deposits, cave sediments, glacial sediments, paleolake shore ridges and river terraces). The calibration of dose rate of the built-in β radiation source of the luminescence dating instrument for the single-grain method also needs to be conducted through the single-grain test of the standard quartz, which puts forward more stringent requirements for the dose consistency among standard quartz grains.

An existing quartz reference sample for calibration of the luminescence dating instrument is mainly sourced from Risø Laboratory in Denmark, and no scientific research institutions in China have carried out the development of the standard quartz. However, the latest research has shown that there is an approximately 8% underestimation of the dose in the standard quartz produced before October 2019 (Autzen et al., 2022). This result has caused serious trouble to all luminescence dating laboratories.

### SUMMARY

An objective of the present disclosure is to provide a preparation method for a quartz reference sample for calibration of a luminescence dating instrument to solve the problems in the related technology, which makes the loading of a sample convenient and a dose of the standard quartz more accurate.

To achieve the foregoing objective, the present disclosure provides the following solutions.

The present disclosure provides a preparation method for a quartz reference sample for calibration of a luminescence dating instrument, including the following steps:
step one, preparation of loading device: preparing a quartz glass front wall and a quartz glass rear wall, where the quartz glass front wall and the quartz glass rear wall are both flat plates and configured to sandwich granular quartz samples, and the quartz glass front wall is closer to a radiation source than the quartz glass rear wall; preparing an annular gasket, where the annular gasket is placed between the quartz glass front wall and the quartz glass rear wall, and a center hole of the annular gasket is configured for placing the quartz samples;
step two, loading of quartz: placing the annular gasket on a front side surface of the quartz glass rear wall, placing the quartz samples in the center hole of the annular gasket, and placing the quartz glass front wall on a front side surface of the annular gasket;
step three, irradiation of quartz: wrapping the loading device with aluminum foil, placing the loading device on a dedicated stand, and positioning the dedicated stand at a measuring point of a reference radiation field and irradiating the loading device;
step four, parameter assessment: measuring an air kerma rate at the measuring point;
step five, calculating a conversion coefficient from air kerma to an absorbed dose of quartz;
step six, calculating an absorbed dose of the quartz samples according to the air kerma rate, the conversion coefficient and irradiation time;
step seven, grouping the quartz samples prepared, and then measuring the quartz samples with the luminescence dating instrument; calculating a ratio of a between-group variance to a within-group variance by adopting a one-way analysis of variance method to assess the homogeneity of the quartz samples; and
step eight, placing the irradiated quartz samples in a shielding box, and taking out the quartz samples at different time points after irradiation for measurement and reading, respectively; calculating a slope of a linear fitting equation and a standard deviation thereof by using linear regression fitting, and assessing the stability of the absorbed dose of quartz through a degree of difference between the slope and 0.

Preferably, in step one, if the radiation source is Cs-137 with energy of 662 keV, a thickness of the quartz glass front wall is at least 0.55 mm; and if the radiation source is Co-60 with energy of 1.25 MeV, the thickness of the quartz glass front wall is at least 2 mm, and a thickness of the quartz glass rear wall is at least 0.5 mm.

Preferably, a thickness of the annular gasket is configured to be not greater than 1 mm, so that a loading thickness of the quartz samples does not exceed 1 mm.

Preferably, the center hole of the annular gasket is a circular hole or square hole.

Preferably, a lower end of the loading device is fixed to the dedicated stand, or an upper end of the loading device is hoisted on the dedicated stand.

Optionally, the dedicated stand includes a pair of mutually parallel first vertical plates and a pair of mutually parallel second vertical plates, an upper end of each of the first vertical plates is provided with a first upper slot, and a lower end of each of the first vertical plates is provided with two first lower slots; an upper end of each of the second vertical plates is provided with two second upper slots; the first vertical plates are perpendicular to the second vertical plates; the two first lower slots of each of the first vertical plates are inserted into the second upper slots of the pair of second vertical plates, respectively, and the lower end of the loading device is inserted into the first upper slot to fix the lower end of the loading device to the dedicated stand in an inserting manner.

Optionally, the dedicated stand includes a pair of mutually parallel first vertical plates, a pair of mutually parallel second vertical plates, and one third vertical plate; an upper end of each of the first vertical plates is provided with a first upper slot, and a lower end of each of the first vertical plate is provided with two first lower slots; an upper end of each of the second vertical plates is provided with two second upper slots; the first vertical plates are perpendicular to the second vertical plates; the two first lower slots of each of the first vertical plates are inserted into the second upper slots of the pair of second vertical plates, respectively, and both ends of the third vertical plate are inserted into the first upper slots of the pair of first vertical plates, respectively; and the upper end of the loading device is connected to the third vertical plate by a suspension line to hoist the upper end of the loading device on the dedicated stand.

Optionally, in step 5, a corresponding model is established by using Monte Carlo software, a standard quartz integration region or detector is placed in a corresponding region to simulate a conversion coefficient from the air kerma to the absorbed dose for monoenergetic photons, and then integration is performed through a fluence spectrum and the conversion coefficient of the monoenergetic photon according to an energy spectrum to obtain a mean energy spectrum of the conversion coefficient.

Optionally, in step 5, a corresponding model is established by using Monte Carlo software, actual energy spectrum data at the measuring point of the radiation field is input to calculate the air kerma and the absorbed dose of quartz to directly obtain the conversion coefficient from the air kerma to the absorbed dose.

Optionally, in step 7, the quartz samples irradiated are divided into different samples, a portion is taken from each of the different samples, the portions taken from the different samples are placed onto aluminum trays in ten luminescence dating instruments for measurement; a one-way analysis of variance method is configured to determine whether a systematic deviation exists between groups of measurements by comparing the between-group variance and the within-group variance; and if the ratio of the between-group variance to the within-group variance is less than a critical value of a statistical test, the quartz samples are considered homogeneous.

Compared with the related technology, some embodiments have the following technical effects.

In the present disclosure, two flat quartz glass plates are used to sandwich the quartz samples, so that the quartz samples are distributed in a single-layer, planar configuration, thereby reducing dose attenuation differences caused by variations in sample thickness and improving the uniformity of absorbed doses among the quartz samples.

The present disclosure has specific requirements for the thickness of the quartz. If the radiation source is Cs-137 with the energy of 662 keV, a thickness of the quartz glass front wall is at least 0.55 mm. If the radiation source is Co-60 with the energy of 1.25 MeV, the thickness of the quartz glass front wall is at least 2 mm, and the thickness of the quartz glass rear wall is at least 0.5 mm. This facilitates the irradiation of the quartz samples under a charged-particle equilibrium state, ensures that scattered particles in a back area of the quartz sample can be compensated during irradiation, and is more conducive to stable assessment of the absorbed dose of the quartz sample.

Two layers of quartz glass plates are designed, with an annular gasket in the middle. The quartz grains are laid flat in the center hole of the annular gasket, so that the quartz glass front wall and the quartz glass rear wall are attached to the annular gasket from both sides, respectively, which facilitates the uniform spreading and taking out of the granular quartz samples.

According to the present disclosure, the quartz glass is selected as the material of the loading device because its mass-energy absorption coefficient is close to that of the quartz sample. As a result, spectral distortion of the incident radiation is minimized when the radiation passes through the loading device and the quartz sample, thereby improving the accuracy and reliability of absorbed dose assessment.

The present disclosure adopts a light-shielding method of wrapping the loading device with aluminum foil. The aluminum foil has better light-shielding effect and known composition, so that the influence of the aluminum foil on the absorbed dose of the quartz sample can be accurately evaluated, making the absorbed dose value of the quartz accurate.

In a preferred scheme of the present disclosure, the quartz sample and the loading device can be placed naked in a radiation field for irradiation by means of lower-end fixation or upper-end hoisting, thereby ensuring that the quartz sample is not affected by back scattering and making a measurement result more accurate and reliable.

In a preferred scheme, multiple calculation ways can be selected when calculating the conversion coefficient, with relatively high flexibility.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a diagram of a preparation method for a quartz reference sample for calibration of a luminescence dating instrument according to an embodiment of the present disclosure;

FIG. 2 is a diagram of one assembly way of a dedicated stand and a loading device;

FIG. 3 is a diagram showing the absorbed dose per unit fluence and the kerma per unit fluence as functions of the depth of the quartz front wall under Cs-137 irradiation conditions;

FIG. 4 is a diagram showing the absorbed dose per unit fluence and the kerma per unit fluence as functions of the depth of the quartz front wall under Co-60 irradiation conditions;

In the drawings: 1 loading device, 2 dedicated stand; 3 suspension line; 21 first vertical plate; 22 second vertical plate; 23 third vertical plate.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. Based on the embodiments in the present disclosure, all other embodiments obtained by those of ordinary skill in the art without making creative labor fall within the scope of protection of the present disclosure.

An objective of the present disclosure is to provide a preparation method for a quartz reference sample for calibration of a luminescence dating instrument to solve the problems in the related technology, making a dose of standard quartz more accurate.

To make the foregoing objectives, features and advantages of the present disclosure more apparent and easier to understand, the present disclosure will be further described in detail with the accompanying drawings and specific embodiments.

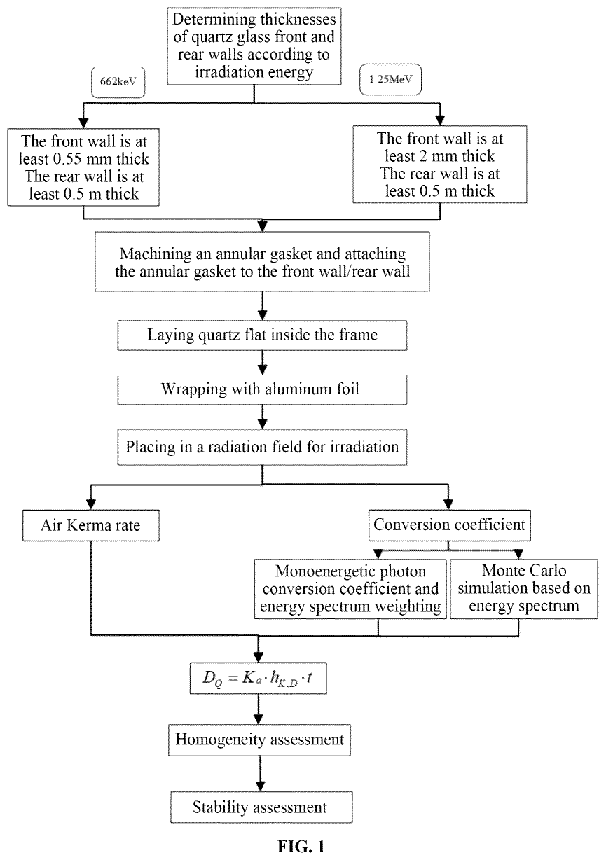

With reference to FIG. 1 to FIG. 4, this embodiment provides a preparation method for a quartz reference sample for calibration of a luminescence dating instrument, including the following steps.

Step one, preparation of loading device: a quartz glass front wall and a quartz glass rear wall are prepared, where the quartz glass front wall and the quartz glass rear wall are both flat plates and configured to sandwich granular quartz samples, and the quartz glass front wall is closer to a radiation source than the quartz glass rear wall; an annular gasket is prepared and placed between the quartz glass front wall and the quartz glass rear wall, and a center hole of the annular gasket is configured for placing the quartz samples.

Step two, loading of quartz: the annular gasket is placed on a front side surface of the quartz glass rear wall, the quartz samples are placed in the center hole of the annular gasket, and the quartz glass front wall is placed on a front side surface of the annular gasket.

Step three, irradiation of quartz: the loading device, after being wrapped with aluminum foil, is mounted on a dedicated stand and placed at a measuring point of a reference radiation field and irradiated.

Step four, parameter assessment: an air kerma rate at the measuring point is measured.

Step five, a conversion coefficient from air kerma to an absorbed dose of quartz is calculated.

Step six, an absorbed dose of the quartz samples is calculated according to the air Kerma rate, the conversion coefficient and irradiation time.

Step seven, the quartz samples prepared are grouped and then measured with the luminescence dating instrument; and a ratio of a between-group variance to a within-group variance is calculated by adopting a one-way analysis of variance method to assess the homogeneity of the quartz samples.

Step eight, the irradiated quartz samples are placed in a shielding box (such as a lead tank), the quartz samples are taken out at different time points after irradiation for measurement, respectively; a slope of a linear fitting equation and a standard deviation thereof are calculated by using linear regression fitting, and the stability of the absorbed dose of quartz is assessed through a degree of difference between the slope and 0.

An operating principle of the preparation method for a quartz reference sample for calibration of a luminescence dating instrument in this embodiment is as follows.

In the prior art, the loading device 1 is generally a hollow cylinder structure, resulting in inconsistent absorbed doses of the quartz samples at different radial positions to irradiation. In this embodiment, two pieces of flat quartz glass are configured to sandwich the quartz samples therebetween, so as to reduce dose attenuation differences caused by thickness variations and improve the consistency of absorbed doses among the quartz samples.

If the quartz particle has a small diameter (about 250 nm), a foregoing flat-shaped distribution manner is adopted, and it is rather difficult to load and take out the quartz samples through a narrow slit. To this end, two layers of quartz glass plates are designed, with an annular gasket in the middle. The quartz grains are laid flat in the center hole of the annular gasket, so that the quartz glass front wall and the quartz glass rear wall are attached to the annular gasket from both sides to facilitate uniform spreading and taking out of the granular quartz samples.

In the prior art, a material of the loading device 1 is generally soda glass, polyethylene, and the like. In this embodiment, the quartz glass with a small difference in mass-energy absorption coefficient from that of the quartz samples is used as the material for the loading device, which can better ensure that a fluence spectrum of the radiation changes slightly when passing through an irradiation device and the quartz samples, making an assessment value more accurate and reliable.

In the prior art, a conventional light-shielding method for the loading device 1 involves wrapping with a black adhesive tape, but the composition of the black adhesive tape is unknown, making it incapability to ensure the influence of the black adhesive tape on the absorbed dose of the quartz samples. In this embodiment, the light-shielding method of wrapping the loading device with aluminum foil is adopted, the aluminum foil has better light-shielding effect and known composition, the influence of the aluminum foil on the absorbed dose of the quartz samples can be accurately assessed, making the absorbed dose value of the quartz samples accurate.

With the foregoing improvements, the preparation method in this embodiment can make the dose of the standard quartz more accurate. However, the dose of some of the standard quartz may still fail to meet the requirements. These samples should be eliminated according to corresponding standards after Step 7 and Step 8.

As a possible example, in Step one, if the radiation source is Cs-137, a thickness of the quartz glass front wall is at least 0.55 mm. If the radiation source is Co-60, the thickness of the quartz glass front wall is at least 2 mm, and a thickness of the quartz glass rear wall is at least 0.5 mm.

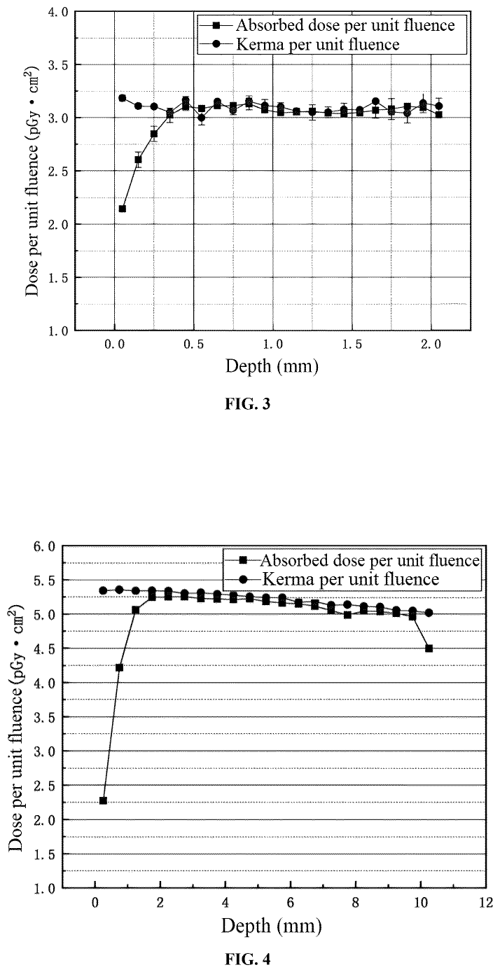

It should be noted that the function of the quartz glass front wall is to ensure that the quartz samples are irradiated under a charged particle equilibrium state when being exposed to radiation. The function of the quartz glass rear wall is to ensure that scattered particles at a back area can be compensated when the quartz samples are exposed to radiation. After calculation, if the radiation source is Cs-137 (with the energy of 662 keV), the thickness of the quartz glass front wall is at least 0.55 mm, with experimental results shown in FIG. 3; and if the radiation source is Co-60 (with the energy of 1.25 MeV), the thickness of the quartz glass front wall is at least 2 mm, and the thickness of the quartz glass rear wall is at least 0.5 mm, with experimental results shown in FIG. 4.

As shown in FIG. 3, a relationship between the depth where the quartz particles are located (where the depth refers to a distance from a rear surface of the quartz glass front wall) and the absorbed dose per unit fluence and the kerma per unit fluence under Cs-137 irradiation conditions is shown. It can be seen that at a depth of 0.55 mm, the absorbed dose per unit fluence is equal to the kerma per unit fluence, indicating that the charged particle equilibrium is achieved.

As shown in FIG. 4, a relationship between the depth where the quartz particles are located and the absorbed dose per unit fluence and the kerma per unit fluence under Co-60 irradiation conditions is shown. It can be seen that at a depth of 2 mm, the absorbed dose per unit fluence is equal to the kerma per unit fluence, indicating that the charged particle equilibrium is achieved.

As a possible example, a thickness of the annular gasket is not greater than 1 mm, so that a loading thickness of the quartz samples does not exceed 1 mm. For example, the thickness of the annular gasket is preferably 1 mm.

As a possible example, the center hole of the annular gasket is a square hole or circular hole.

For example, the quartz glass front wall, the quartz glass rear wall and the annular gasket have the same outer contour dimension, and a spacing between an inner contour and an outer contour of the annular gasket is 1 cm.

As a possible example, a lower end of the loading device 1 is fixed to the dedicated stand 2, or an upper end of the loading device is hoisted on the dedicated stand 2.

In the prior art, the loading device 1 is generally fixed onto organic glass, and back scattering of the organic glass needs to be considered when calculating the absorbed dose of the quartz. In this embodiment, the quartz sample and the loading device can be placed naked in a radiation field for irradiation by means of lower-end fixation or upper-end hoisting, thereby ensuring that the quartz sample is not affected by back scattering and making a measurement result more accurate and reliable.

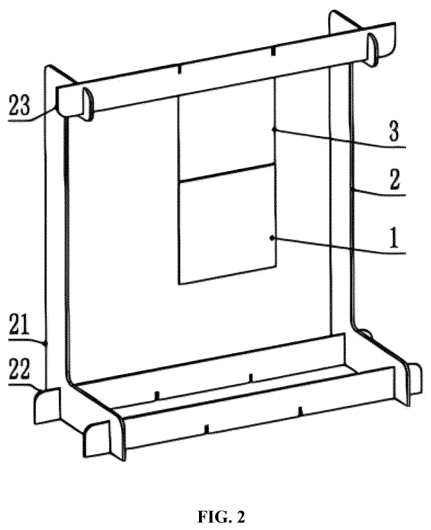

With reference to FIG. 2, when an upper-end hoisting method is employed, the dedicated stand 2 includes a pair of mutually parallel first vertical plates 21, a pair of mutually parallel second vertical plates 22, and one third vertical plate 23. An upper end of the first vertical plate 21 is provided with one first upper slot, and a lower end of the first vertical plate 21 is provided with two first lower slots. An upper end of the second vertical plate 22 is provided with two second upper slots. The first vertical plate 21 and the second vertical plate 22 are perpendicular to each other. The two first lower slots of the first vertical plate 21 are inserted into the second upper slots of the two second vertical plates 22, respectively. Both ends of the third vertical plate 23 are inserted into the first upper slots of the two first vertical plate 23, respectively, and the upper end of the loading device 1 is connected to the third vertical plate 23 by a suspension line 3, thereby hoisting the upper end of the loading device 1 onto the dedicated stand 2.

When a lower-end fixation method is employed, the dedicated stand 2 includes a pair of mutually parallel first vertical plates 21 and a pair of mutually parallel second vertical plates 22. An upper end of the first vertical plate 21 is provided with one first upper slot, and a lower end of the first vertical plate 21 is provided with two first lower slots. An upper end of the second vertical plate 22 is provided with two second upper slots. The first vertical plate 21 and the second vertical plate 22 are perpendicular to each other. The two first lower slots of the first vertical plate 21 are inserted into the second upper slots of the two second vertical plates 22, respectively, and a lower end of the loading device 1 is inserted into the first upper slot, thereby fixing the lower end of the loading device 1 to the dedicated stand 2 in an inserting manner.

By employing the dedicated stand 2 with the foregoing inserting structure, the dedicated stand can be conveniently disassembled when not in use, thereby reducing a storage space.

For example, a sum of depths of the first lower slot and the second upper slot is a height of the second vertical plate 22, so that the lower end of the first vertical plate 21 is flush with the lower end of the second vertical plate 22, thereby improving the stability of the dedicated stand.

For example, the number of the second upper slots at the upper end of the second vertical plate 22 is greater than two, thereby facilitating the adjustment of a position of the first vertical plate 21.

In Step five, there are multiple ways for calculating the conversion coefficient, which can be flexibly selected by those skilled in the art.

For example, when calculating the conversion coefficient, a corresponding model is established using Monte Carlo software, and a standard quartz integration region or detector is placed at a corresponding position to calculate the conversion coefficient from air kerma to absorbed dose in quartz for monoenergetic photons. The conversion coefficients are then weighted and integrated over the photon fluence spectrum of the radiation field to obtain a fluence-spectrum-averaged conversion coefficient.

For example, when calculating the conversion coefficient, a corresponding model is established by using Monte Carlo software, actual energy spectrum data at the measuring point of the radiation field is input to calculate the air kerma and the absorbed dose of quartz to directly obtain the conversion coefficient from the air kerma to the absorbed dose for the radiant matter.

As a possible example, in Step 7, the quartz samples are divided into different samples. A portion is taken from each sample, and the portions taken from the samples are dispensed onto aluminum trays in ten luminescence dating instruments, and then measured by the luminescence dating instruments. A one-way analysis of variance method is configured to determine whether a systematic deviation exists between groups of measurements by comparing the between-group variance and the within-group variance; and if the ratio of the between-group variance to the within-group variance is less than a critical value of a statistical test, the quartz samples are considered homogeneous.

It may be understood that the foregoing parameters can be adjusted when executing the one-way analysis of variance method in Step 7, thereby meeting actual needs.

As a possible example, in Step eight, after the quartz samples are irradiated, a portion is randomly taken out and immediately measured and read by a luminescence dating instrument. The remaining samples are placed in the shielding box, and after one month, a portion of the quartz samples is taken out for the second time, where a time interval between two adjacent extractions of the quartz samples shall not be less than one month.

For example, in Step 8, the quartz samples can be taken out for 13 times, which are taken out right after being placed in the shielding box, and at one month, two months, three months, four months, up to twelve months after being placed in the shielding box, respectively.

As a possible example, the absorbed dose of the quartz samples is not limited to 5 Gy mentioned in the scheme, which may actually be set in a wider range according to requirements and actual conditions. The types of radiation may be X-rays, γ-rays, β-rays, or ray particles such as electrons, which is not limited to 662 keV (Cs-137) and 1.25 MeV (Co60), and can be selected according to requirements and actual conditions.

As a possible example, in Step 4, the air kerma rate at the measuring point used for irradiating the quartz samples in the γ-ray standard radiation field is traceable to a national primary standard for air kerma.

As a possible example, a calculation formula of Step six is as follows:

$${D}_{Q} = {\dot{K}}_{a} \cdot {h}_{K , D} \cdot t = {N}_{K}^{r e f} \cdot {I}_{c o r r}^{r e f} \cdot {k}_{tp} \cdot {h}_{K , D} \cdot t$$

where \dot{K}ₐ is air Kerma at a position where the reference radiation field is intended to be used for irradiating the quartz samples, which is measured by the standard ionization chamber,

$${N}_{K}^{r e f}$$

is a correction factor of an ionization chamber traced to the benchmark,

$${I}_{c o r r}^{r e f}$$

is an ionization current of the ionization chamber, kₜₚ is temperature and pressure correction of ambient air, h_{K,D} is a conversion coefficient from the air Kerma to the absorbed dose of the quartz samples, and t is irradiation time.

Calculation formulas of Step eight is as follow:

$${b}_{1} = \frac{{\sum }_{i = 1}^{n} ( {X}_{i} - \overline{X} ) ( {Y}_{i} - \overline{Y} )}{{\sum }_{i = 1}^{n} {( {X}_{i} - \overline{X} )}^{2}}$$

$${s}^{2} = \frac{{\sum }_{i = 1}^{n} {( {Y}_{i} - {b}_{0} - {b}_{1} {X}_{i} )}^{2}}{n - 2}$$

$$s ( {b}_{1} ) = \frac{s}{{\sqrt{{\sum }_{i = 1}^{n} ( {X}_{i} - \overline{X}} )}^{2}}$$

Several examples are used for illustration of the principles and implementations of the present disclosure. The description of the embodiments is merely used to help illustrate the method and its core principles of the present disclosure. In addition, a person of ordinary skill in the art can make various modifications in terms of specific implementations and scope of application in accordance with the teachings of the present disclosure. In conclusion, the content of this specification shall not be construed as a limitation to the present disclosure.

What is claimed is:

1. A preparation method for a quartz reference sample for calibration of a luminescence dating instrument, comprising following steps of:
step one, preparation of loading device: preparing a quartz glass front wall and a quartz glass rear wall, wherein the quartz glass front wall and the quartz glass rear wall are both flat plates and configured to sandwich granular quartz samples, and the quartz glass front wall is closer to a radiation source than the quartz glass rear wall; preparing an annular gasket, wherein the annular gasket is placed between the quartz glass front wall and the quartz glass rear wall, and a center hole of the annular gasket is configured for placing the quartz samples;
step two, loading of quartz: placing the annular gasket on a front side surface of the quartz glass rear wall, placing the quartz samples in the center hole of the annular gasket, and placing the quartz glass front wall on a front side surface of the annular gasket;
step three, irradiation of quartz: the loading device, after being wrapped with aluminum foil, is mounted on a dedicated stand and placed at a measuring point of a reference radiation field and irradiated;
step four, parameter assessment: measuring an air kerma rate at the measuring point;
step five, calculating a conversion coefficient from air kerma to absorbed dose of quartz;
step six, calculating absorbed dose of the quartz samples according to the air kerma rate, the conversion coefficient and irradiation time;
step seven, grouping the quartz samples prepared, and then measuring the quartz samples with the luminescence dating instrument; calculating a ratio of a between-group variance to a within-group variance by adopting a one-way analysis of variance method to assess the homogeneity of the quartz samples; and
step eight, placing the irradiated quartz samples in a shielding box, and taking out the quartz samples at different time points after irradiation for measurement and reading, respectively; calculating a slope of a linear fitting equation and a standard deviation thereof by using linear regression fitting, and assessing the stability of the absorbed dose of quartz through a degree of difference between the slope and 0.

2. The preparation method for the quartz reference sample for calibration of the luminescence dating instrument according to claim 1, wherein in step one, if the radiation source is Cs-137 with energy of 662 keV, a thickness of the quartz glass front wall is at least 0.55 mm; and if the radiation source is Co-60 with energy of 1.25 MeV, the thickness of the quartz glass front wall is at least 2 mm, and a thickness of the quartz glass rear wall is at least 0.5 mm.

3. The preparation method for the quartz reference sample for calibration of the luminescence dating instrument according to claim 1, wherein a thickness of the annular gasket is configured to be not greater than 1 mm, so that a loading thickness of the quartz samples does not exceed 1 mm.

4. The preparation method for the quartz reference sample for calibration of the luminescence dating instrument according to claim 1, wherein the center hole of the annular gasket is a circular hole or square hole.

5. The preparation method for the quartz reference sample for calibration of the luminescence dating instrument according to claim 1, wherein a lower end of the loading device is fixed to the dedicated stand, or an upper end of the loading device is hoisted on the dedicated stand.

6. The preparation method for the quartz reference sample for calibration of the luminescence dating instrument according to claim 5, wherein the dedicated stand comprises a pair of mutually parallel first vertical plates and a pair of mutually parallel second vertical plates, an upper end of each of the first vertical plates is provided with a first upper slot, and a lower end of each of the first vertical plates is provided with two first lower slots; an upper end of each of the second vertical plates is provided with two second upper slots; the first vertical plates are perpendicular to the second vertical plates; the two first lower slots of each of the first vertical plates are inserted into the second upper slots of the pair of second vertical plates, respectively, and the lower end of the loading device is inserted into the first upper slot to fix the lower end of the loading device to the dedicated stand in an inserting manner.

7. The preparation method for the quartz reference sample for calibration of the luminescence dating instrument according to claim 5, wherein the dedicated stand comprises a pair of mutually parallel first vertical plates, a pair of mutually parallel second vertical plates, and one third vertical plate; an upper end of each of the first vertical plates is provided with a first upper slot, and a lower end of each of the first vertical plate is provided with two first lower slots; an upper end of each of the second vertical plates is provided with two second upper slots; the first vertical plates are perpendicular to the second vertical plates; the two first lower slots of each of the first vertical plates are inserted into the second upper slots of the pair of second vertical plates, respectively, and both ends of the third vertical plate are inserted into the first upper slots of the pair of first vertical plates, respectively; and the upper end of the loading device is connected to the third vertical plate by a suspension line to hoist the upper end of the loading device on the dedicated stand.

8. The preparation method for the quartz reference sample for calibration of the luminescence dating instrument according to claim 1, wherein in step 5, a corresponding model is established by using Monte Carlo software, a standard quartz integration region or detector is placed in a corresponding region to simulate a conversion coefficient from the air kerma to the absorbed dose for monoenergetic photons, and then integration is performed through a fluence spectrum and the conversion coefficient of the monoenergetic photon according to an energy spectrum of an irradiated radiant matter to obtain a mean energy spectrum of the conversion coefficient.

9. The preparation method for the quartz reference sample for calibration of the luminescence dating instrument according to claim 1, wherein in step 5, a corresponding model is established by using Monte Carlo software, actual energy spectrum data at the measuring point of the radiation field is input to calculate the air kerma and the absorbed dose of quartz to directly obtain the conversion coefficient from the air kerma to the absorbed dose for a radiant matter.

10. The preparation method for the quartz reference sample for calibration of the luminescence dating instrument according to claim 1, wherein in step 7, the quartz samples irradiated are divided into different samples, a portion is taken from each of the different samples, the portions taken from the different samples are placed onto aluminum trays in ten luminescence dating instruments for measurement; a one-way analysis of variance method is configured to determine whether a systematic deviation exists between groups of measurements by comparing the between-group variance and the within-group variance; and if the ratio of the between-group variance to the within-group variance is less than a critical value of a statistical test, the quartz samples are considered homogeneous.
